(19) United States
(12) Patent Application Publication
(10) Pub. No.: US 2013/0265856 A1
(43) Pub. Date: Oct. 10, 2013

(54) THERMOACOUSTIC SENSOR

(71) Applicant: THE GOVERNORS OF THE UNIVERSITY OF ALBERTA, (US)

(72) Inventors: Michael Choi, Edmonton (CA); Jie Chen, Edmonton (CA)

(73) Assignee: THE GOVERNORS OF THE UNIVERSITY OF ALBERTA, EDMONTON (CA)

(21) Appl. No.: 13/858,812

(22) Filed: Apr. 8, 2013

Related U.S. Application Data
(60) Provisional application No. 61/621,543, filed on Apr. 8, 2012.

(51) Int. Cl. H04R 23/00

(52) U.S. Cl. CPC H04R 23/002
USPC 367/140

(57) ABSTRACT

A close-proximity thermoacoustic sensor that can determine radiated ultrasound intensities by directly coupling a transducer via a coupling medium. The sensor captures the beam, converts the ultrasound power into heat, and indirectly measures the spatial average time average ultrasound intensity (Iₛₐₜₐ) by dividing the calculated power by the beam-cross-section (or the nominal area of the transducers).

### CROSS-REFERENCE TO RELATED APPLICATIONS

This application claims the benefit under 35 USC 119(e) of U.S. provisional application No. 61/621,543 filed Apr. 8, 2012. This provisional application is hereby incorporated by reference herein in its entirety.

### FIELD

Thermoacoustic sensors

### BACKGROUND

Ultrasound has a wide range of biomedical applications from imaging to promoting cell growth (Shaw 2008). For biological experiments, it is important to regulate the acoustic output to ensure the quality and consistency of each trial. If not monitored properly, the under-application of ultrasound in high intensity focused ultrasound (HIFU)-based kidney stone disintegration can lead to incomplete treatment, while the over-application of ultrasound in LIPUS applications can lead to cell death (Shaw 2008). Acoustic output parameters are typically evaluated using a hydrophone or a radiation force balance. Hydrophones are considered the universal instrument used to characterize acoustic field parameters, such as pressure waveforms or beam profiles. However, operation of a hydrophone can be technically difficult, time-consuming, and expensive (Wilkens 2010a, 2004). For determining ultrasound output power, the accepted technique is the use of a radiation force balance (Shaw 2008). A radiation force balance requires that the ultrasound beam must be transmitted into a chamber containing degassed water onto an absorbing or reflecting target, which must intercept the entire beam (Shaw 2008).

Although the radiation force balance is the gold standard for measuring ultrasound intensity, it is not possible for real-time monitoring in certain settings, for example bioreactors, or in clinic to measure ultrasound intensities during treatment. Foreseeing these needs, we have proposed a close-proximity thermoacoustic sensor.

### SUMMARY

In one embodiment, a thermoacoustic ultrasound sensor comprises a transducer and an ultrasound sensor directly acoustically coupled to the transducer and an electronic processing unit connected to process signals from the ultrasound sensor.

In various embodiments, acoustic coupling may be achieved by (1) placing a layer of material that conducts ultrasound such as gel, gel pad, or agar between matching surfaces of the transducer and the sensor and pressing the transducer and sensor together, (2) matching surfaces of the transducer and sensor glued together, and (3) matching surfaces of the transducer and sensor being pressed together with many points of solid contact, as for example by using a suitable material such as rubber on both transducer and sensor to achieve direct coupling. By having matching surfaces of the transducer and sensor directly or acoustically coupled more energy is transferred from the transducer into the sensor and this permits more accurate calibration. In various embodiments, matching of the contacting faces may comprise the contacting faces of the transducer and the sensor being flat, but both may for example have the same curvature but one inverted from the other, one for example being convex and the other concave. In various embodiments, the face of the sensor that contacts a face of the transducer is larger in area than the face of the transducer to ensure high coupling efficiency of energy into the sensor. In various embodiments, the sensor comprises a cylinder, and a temperature sensor is attached to the cylinder. Preferably, the cylinder, at the point of attachment to the temperature sensor, is made of a thermally conductive material such as a metal, for example copper, or a metal with greater thermal conductivity than copper. Thus for example, in the disclosed embodiment using a cylindrical housing for the sensor, the circular end wall furthest from the coupling with the transducer may be made of or partially made of copper. The ultrasound sensor and transducer may face each other across a medium that is confined between the ultrasound sensor and transducer and, in operation, ultrasound only approaches the ultrasound sensor on one side only of the ultrasound sensor.

### BRIEF DESCRIPTION OF THE DRAWINGS

Embodiments of a thermoacousting sensor will now be described, with reference to the drawings by way of example, in which:

FIG. 1 shows an exemplary thermoacoustic sensor design, showing a close proximity thermoacoustic sensor placed in direct contact with the ultrasound transducer via degassed water medium, and on the left side showing the principle of operation of an ultrasound transducer of the type that uses a cylinder in cylinder design; FIGS. 1A and 1B show exemplary thermoacoustic sensors and ultrasound transducers of different shapes; FIG. 1C shows an exemplary thermoacoustic sensor with a hole at the back of the cylinder for wires.

FIG. 2 shows an exemplary hardware block diagram for the sensor of FIG. 1;

FIG. 3 shows an exemplary firmware flowchart for the exemplary thermoacoustic sensor;

FIG. 4 is a graph showing Temperature vs. Time curve measured by the sensor at 40 mW/cm². The greatest increase in temperature is observed between t=0 seconds to t=150 seconds, and thermal equilibrium is reached at t=400 seconds.

FIG. 5 is a graph showing an evaluation of the thermoacoustic sensor by comparing measurements made with the thermoacoustic sensor with measurements taken using a radiation force balance. The linear line represents a 1:1 relationship between the Radiation Force Balance and the Thermoacoustic Sensor.

### DETAILED DESCRIPTION

Thermoacoustic sensors that measure the transformation of the incident ultrasonic energy into heat have the potential to be an alternative approach to determine ultrasound intensity. These sensors are based on the transformation of incident ultrasonic energy into heat inside a small cylindrical absorber, and the detection of the temperature rise on the rear side of the absorber (Wilkens 2010a). Previous thermoacoustic sensor operation has required the sensor and transducer to be placed in a large water tank, similar to hydrophone or radiation force balance measurements (Wilkens 2010a, 2010b, 2004, 2002; Fay 1994; Fay 1996b). To further simplify thermoacoustic sensor operation, we designed and tested a close-proximity thermoacoustic sensor that can determine radiated ultrasound intensities by directly coupling a transducer via a coupling medium. Compared to the previous thermoacoustic sensors that cannot take measurements without placing the senor and transducer in a large water tank, the close-proximity thermoacoustic sensor can take measurements in air without complicated set-up procedures.

In a manner of operation of the sensor, the sensor captures the beam, converts the ultrasound power into heat, and indirectly measures the spatial average time average ultrasound intensity (Isata) by dividing the calculated power by the beam-cross-section (or the nominal area of the transducers). In an embodiment of the design, used for testing, a thin copper sheet was adhered to the back face of the sensor to increase heat diffusivity 1000-fold, enabling a uniform temperature distribution across the back face. An embedded system design was implemented using an Atmel microcontroller programmed with a least squares algorithm to fit measured temperature vs. time data to a model describing the temperature rise averaged across the backside of the sensor in relation to the applied ultrasound intensity.

An advantage over the radiation force balance is its ability to make measurements in the field (i.e. during equipment service activities). Compared to thermoacoustic sensor designs outlined in literature and in patents, the design implemented in this paper also has several novel components. The implementation of a thin metal layer increases heat conduction at the back of the absorber. The metal layer also reduces the dependence of the ultrasound transducer's focal point. The results show that the copper layer can increase heat diffusion 1000 fold compared to plexiglass alone, and reduce the sensor's error. The setup is more convenient than previously demonstrated setups that require the sensor and transducer to be placed in a large water bath. Finally, an embedded system design utilizing a microcontroller running a least squares algorithm was implemented to process the data in real time.

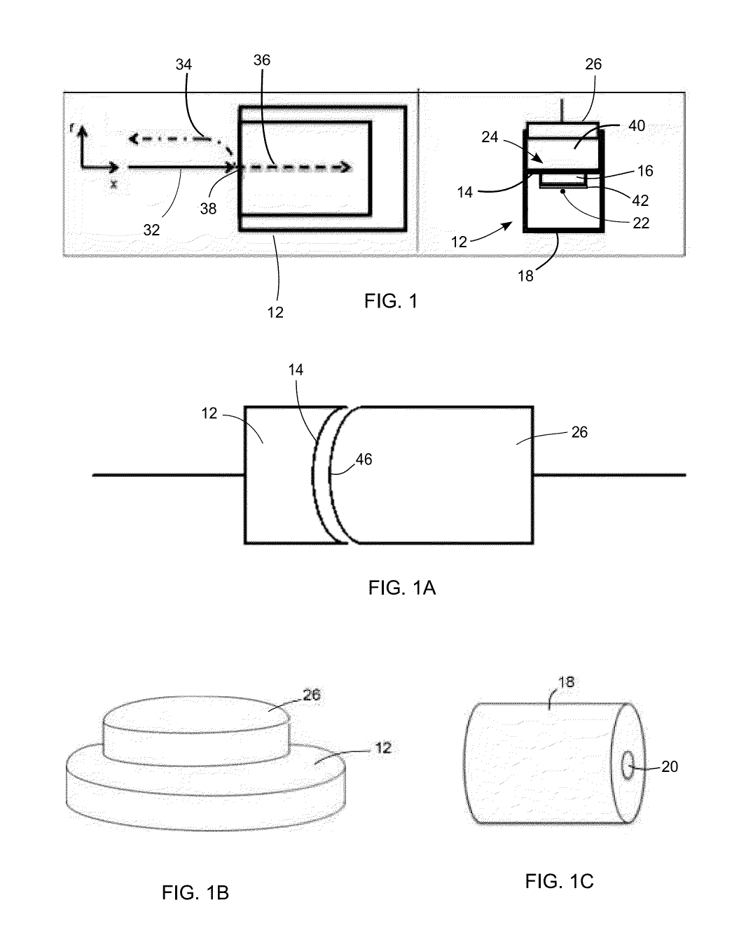

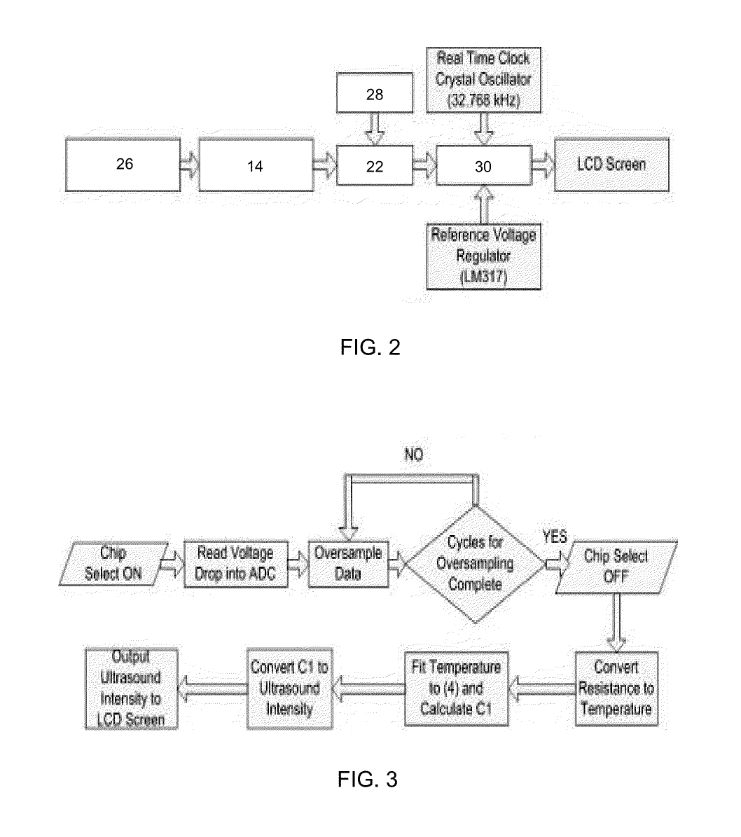

Referring to FIG. 1, the design as tested uses a cylindrical absorber design. In a cylindrical absorber design, the area where temperature readings are taken is thermally isolated, reducing the influence of ambient temperature. The cylindrical absorber design as tested comprises of a transducer 26 directly acoustically coupled to a sensor 12 defined by front face 14 and solid interior cylinder 16 within a hollow cylinder 18. The front face 14 and the solid interior cylinder 16 together form an absorber 24. The cylinder 16 is centered on the front face 14. The front face 14 may be screwed into the hollow cylinder 18. The main purpose of the hollow cylinder 18 is to isolate the absorbing component from the surrounding environmental temperature. The hollow cylinder 18 may be designed with an O-ring to seal the junction where the front face 14 screws into the cylinder 18. A thermistor 22 is fixed to the back center of the cylinder 16. A hole 20 may be provided at the back of the hollow cylinder 18 for wires (shown in FIG. 1C, and illustrated schematically by connecting lines in FIG. 2) to connect the thermistor 22 to the electronic components shown in FIG. 2. This hole 20 may be sealed with a waterproof silicone sealant.

In the sensor shown in FIG. 1, the cylinder 18 forms a housing for both the transducer 26 and sensor part 12 with cylinder 16. The transducer 26 is at one end of the cylinder 18. The sensor 12 is at the opposed end of the cylinder 18. Sensor 12 including the cylinder 16 and transducer 26 are fixed to the housing for example by being threaded within the cylinder 18. The sensor 12 and transducer 26 are separated by an enclosed space that is filled with medium 40. The medium is bounded by the cylinder 18 and in the example shown the medium extends radially outward only so far as the sensor part 12, or in other words the cylinder 18 has the same radius in both the sensor part 12 and where it confines the medium 40. The sensor 12 and transducer 26 virtually touch each other. In this case, there is no misalignment and all transmitted ultrasound wave losslessly (in theory) passes into the sensor 12. Also, the ultrasound wave only comes from one side of the sensor 12, which can be achieved as in FIG. 1, where the ultrasound sensor 12 and transducer 26 face each other across a medium 40 that is confined between the ultrasound sensor 12 and transducer 26.

Referring to FIG. 2, hardware of the thermoacoustic sensor comprises three main modules: temperature sensing, processing, and communication. In the following sections, each of these components will be discussed in detail.

A thermistor is a type of resistor. The main property of a thermistor is its resistance varies significantly with its temperature. There are two types of thermistors: positive temperature coefficient (PTC) thermistors, and negative temperature coefficient (NTC) thermistors. These classifications depend on the sign of the temperature coefficient (kT) in the linear approximation equation that describes the operation of a thermistor,

ΔR=k−TΔT (1)

where ΔR is the change in resistance, and ΔT is change in temperature. In contrast, resistors are designed to have a temperature coefficient as close to zero as possible in order to not be effected by the surrounding temperature.

Thermistors differ from resistance temperature detectors (RTD) with regards to the materials used for construction, and performance. RTDs are generally constructed from pure metal, while thermistors are normally made from a ceramic or polymer. Thermistors typically achieve a higher precision within a limited temperature range, while RTDs have the ability to measure greater spans of temperatures.

The drawbacks of using a thermistor include its limited operational range, and self-heating effects. The linear approximation equation is only true over a small temperature range. Additionally, depending on the circuit designed, thermistors can suffer from self-heating effects. If a thermistor is used to calculate a change in temperature by measuring the voltage drop across itself, the current that must be run through the thermistor will generate heat that will raise the temperature of the thermistor above the actual ambient temperature. Low power circuit design is implemented to prevent this.

For the exemplary thermoacoustic sensor, a thermistor 22 was implemented to measure the changes in temperature due to absorbed ultrasonic energy. A Honeywell discrete thermistor was chosen. This glass bead thermistor has a rapid response time of 0.5 seconds in still air, is micro sized measuring only 0.36 mm in diameter, is sensitive to changes to temperature and has excellent long term stability. The thermistor was secured firmly to the back face of the thermoacoustic absorber 24 using a small piece of electrical tape and the leads were soldered onto longer wires that connected back into the thermoacoustic sensor printed circuit board. At room temperature, the thermistor measured 2000 Ohms.

An analog to digital converter (ADC) is used to convert input analog voltage to a digital number proportional to the magnitude of the voltage. The opposite device is a digital to analog converter (DAC), which performs the same function but in reverse. An ADC allows the analog information measured to be manipulated by digital equipment, such as a microcontroller. In this case, the ADC value is calculated using the following equation,

$$A D C = \frac{{V}_{IN} \times {2}^{b}}{{V}_{REF}} \qquad ( 2 )$$

where b is the number of bits of resolution. In this design, the supply voltage (3.3 V) is inputted to the reference voltage pin (VREF), the voltage drop across the thermistor is the input voltage (VIN), and 14 bits of resolution (b) are calculated

An integrated circuit made by MAXIM is used to supply the current to measure the voltage drop across the thermistor. The MAX6682 28, a thermistor to digital converter, was implemented in the circuit. While the MAX6682 28 is capable of calculating the resistance to temperature relationship and communicate with a microcontroller using a serial peripheral interface (SPI), the precision, accuracy, and flexibility of the microcontroller's ADC was preferred. Using the ADC, resolution to the millionth decimal point could be reached, compared to thousandth obtainable using the MAX6682. However, the MAX6682 28 was still used to provide a minute current across the thermistor for the ADC to measure the voltage drop. The power management circuitry built into the MAX6682 reduced the average thermistor current, thus minimizing thermistor self-heating. A 220 μA current is issued across the thermistor during a reading, between conversions the supply current is reduced to 21 μA.

The directly-coupled thermoacoustic sensor disclosed here can be used in various embodiments to measure ultrasound output at any frequency or intensity, in pulsed or continuous modes.

In one embodiment, the system comprises a transducer and electronic processing components. The electronic processing components may be made of a variety of components, for example the ATmega324P, a high performance, low power Atmel AVR 8-bit microcontroller, or other microcontroller may form part of the electronic processing unit for the thermoacoustic sensor. Capable of twenty million instructions per second, with 32 kilobytes of in-system self-programmable flash memory, the ATmega324P 30 was able to carry out the computations required. The main features of the ATmega324P 30 include the real time counter, the analog to digital converter, the programmable serial universal asynchronous receiver/transmitter port, and the internal interrupts. The 44-pin TQFP package was chosen, and programming was carried out using an AVR JTAGICE mkII. The microcontroller was operated at 3.3 V and a processing speed of 12 MHz.

Communication was carried out using a MAX448 RS-485 transceiver (MAXIM). The MAX448 is a low-power, slew rate limited transceiver capable of RS-485 communication. This integrated circuit features a reduced slew rate driver that minimizes electromagnetic interference (EMI) and reduces reflections caused by improperly terminated cables. The MAX448 is capable of error free data transmission up to 250 kbps, and draws between 120 μA and 500 μA of supply current during operation. The RS-485 standard is a communication standard that specifies the electrical characteristics of the driver and receiver. It is used throughout the SonaCell™ system in a master-slave orientation.

As shown in FIG. 1, a thermoacoustic ultrasound sensor comprises a transducer 26 and an ultrasound sensor 12 directly acoustically coupled to the transducer. In various embodiments, acoustic coupling may be achieved by (1) placing a layer of material 40 that conducts ultrasound between matching surfaces of the transducer 26 and the sensor 12 (2) matching surfaces of the transducer 26 and sensor 12 glued together, and (3) matching surfaces of the transducer 26 and sensor 12 being pressed together with many points of solid contact. For example, the matching surfaces may be pressed together by using a suitable material such as rubber on both transducer and sensor to achieve direct coupling. The layer of material 40 that conducts ultrasound may comprise gel, gel pad, agar, a water film, or glue. By having matching surfaces of the transducer and sensor directly or acoustically coupled more energy is transferred from the transducer into the sensor and this permits more accurate calibration. In various embodiments, matching surfaces may comprise rubber surfaces. In various embodiments, matching surfaces of the transducer and the sensor may be flat, or both may for example have the same curvature but one inverted from the other, one for example being convex and the other concave. In various embodiments, the matching surfaces may comprise a face of the sensor and a face of the transducer, and the face of the sensor is larger in area than the face of the transducer to ensure high coupling efficiency of energy into the sensor. In various embodiments, the cylinder 16, at the point of attachment to the temperature sensor 22, is made of a thermally conductive material such as a metal, for example copper, or a metal with greater thermal conductivity than copper such as gold or silver. A thermal paste may be added to the conductive layer. To reduce the sensing time and improve the sensing accuracy, we take the ambient temperature into the consideration. Matching in this context means the surfaces have matched acoustic impedance.

In various embodiments, the housing is cylindrical and has a circular end wall 42 furthest from the coupling with the transducer that is at least partially made of copper. Thus for example, in the disclosed embodiment using a cylindrical housing for the sensor, the circular end wall furthest from the coupling with the transducer may be made of or partially made of copper. In our setup, shown in FIGS. 1, 2 and 3, the acoustic impedances of the ultrasound medium 40 and sensor 12 will determine how much of the ultrasound wave 32 is reflected 34 at the medium-sensor interface 38, and how much of the wave is transmitted 36. The “close proximity” nature of the sensor can cause its measurements to be affected by the ultrasound transducer's self-heating effect, which occurs due to energy lost in the conversion of electrical energy to mechanical energy. In order to mitigate these self-heating effects, our sensor design includes medium 40 such as ultrasound gel or degassed water. The medium 40 can disperse the heat generated by the transducer 26 during measurements and help to resolve the transducer's self-heating effect on the sensor.

The transducer and ultrasound sensor are acoustically coupled by a layer of material that conducts ultrasound and that is placed between matching surfaces of the transducer and the sensor. The medium (degassed water for example, but other materials may be used) in FIG. 1 is the layer of material. Degassed water (water without air bubble) is a very good material for passing ultrasound. That is, there is no attenuation when ultrasound passes through water. “Matching” means, when we measure ultrasound intensity, ultrasound transmitter and ultrasound sensor have to have good impedance matching. Any mismatch can cause inaccurate ultrasound reading. The water is a medium to make sure that all the energy delivered by the transmitter can losslessly pass to the sensor for measurement. We found to immerse ultrasound transducer in water (see FIG. 1) is better than gel or gel pad. The reasons are: When applying gel, there can be inconsistency because different users might apply gel differently (gel thickness, uniformity). Gel pad is better than gel. However misalignment between ultrasound transmitter (or transducer) and ultrasound sensor can also induce errors. Water is a most cheap way for sensing. In addition, water is a good thermal capacitor, which can be used for measuring ambient temperature. The medium in FIG. 1 is thin, the distance between the facing surfaces of the transducer and sensor front face being less, preferably much less than their width (diameter of the cylinder 18 in this case). The layer of material can be water or ultrasound gel or ultrasound glue (those used in medical ultrasound diagnosis). In FIG. 1, the transducer surface is flat. However, some transducers have different shapes. In this embodiment, the front face 46 of the transducer 26 should have the same (matching) curvature as the face 14 of the sensor 12 as shown in FIG. 1A. To avoid misalignment (see FIG. 1B), we usually design the sensor 12 to have a larger area than the transducer 26. Although a wire may be connected to a microprocessor outside the sensor housing for data processing, the electronic processing unit may be embedded everything inside the sensor.

The ideal material for a thermoacoustic sensor combines perfect acoustic impedance matching with strong acoustic absorbance. Acoustic impedance (Z) is related to a material's density (ρ), and acoustic velocity (v), shown in equation (3) (Ensminger 2009). Ultrasound waves are reflected at boundaries where there is a difference in acoustic impedance on each side; this is referred to as an impedance mismatch. A larger impedance mismatch will result in a higher percentage of the incident intensity being reflected (R_{w}) at the boundary (4).

$$\begin{matrix}Z = ρ \times v & ( 3 ) \\ {R}_{w} = {( \frac{{Z}_{2} - {Z}_{1}}{{Z}_{2} + {Z}_{1}} )}^{2} \times 100 \% & ( 4 )\end{matrix}$$

Z₁ and Z₂ correspond to the acoustic impedance of the two materials at the boundary (Ensminger 2009). Neglecting scattering effects, the portion of the ultrasound wave that is not reflected at the boundary is transmitted through the material.

Plexiglass has been successfully used in previous investigations, and is an available material that can be easily processed and quickly assembled in house (Wilkens 2010a, 2004, 2002; Fay 1996b). The inner absorbent cylinder in the sensor designed has a diameter of 20 mm, and an absorber length of 2 mm. Using the acoustic properties from Table 1 and equation (4), 13% of the incident ultrasound intensity will be reflected at the water-plexiglass interface. Ignoring scattering effects, 87% of the ultrasound wave will be transmitted into the plexiglass absorber. The low acoustic impedance of air, the insulating material, will cause 99% of the ultrasound wave to be reflected when it reaches the back of the sensor.

TABLE 1
ACOUSTIC PROPERTIES OF THERMOACOUSTIC SENSOR

| | | Acoustic | | |
|---|---|---|---|---|
| Material | Density (ρ) | Velocity (v) | Acoustic Impedance (Z) | |
| Plexiglass | 1180 kg/m³ | 2700 m/s | 3.19E6 | kg m²/s |
| Degassed | 1000 kg/m³ | 1484 m/s | 1.48E6 | kg m²/s |
| Water | | | | |
| Air | 1.2041 kg/m³ | 343.26 m/s | 413.3 | kg m²/s |

As it travels through the solid medium, the initial transmitted intensity is reduced due to acoustic attenuation. Acoustic attenuation is caused due to the absorption and scattering of the ultrasound wave and is generally dependent on two factors: (i) the material through which the wave is transmitted, and (ii) the frequency of the ultrasound (Ensminger 2009). The ultrasound intensity after being attenuated over a distance x can be calculated using the following equation, where I0 is the initial ultrasound intensity, and μ is the absorption coefficient:

I(x)=I₀e^{-μs} (5)

Myers and Herman investigated the transient temperature evaluation in a theoretical assessment (Myers 2002). They followed the single reflection theory and described a steady state solution and a transient solution to the temperature rise averaged over the absorber's cross-section. They suggested that temperature data collected over time could be fit to a curve with the form,

$${T}_{ave} ( t ) = {\sum }_{n = 0}^{∞} {C}_{n} ( 1 - {e}^{- \frac{t}{τ}} ) \\ where {C}_{n} = \frac{{I}_{0}}{μ k} \frac{16 ( 1 + {e}^{- 2 μ l} )}{π ( 2 n + 1 ) ( {μ}^{2} {l}^{2} + {( 2 n + 1 )}^{2} {π}^{2} )} , and \\ τ = \frac{4 {l}^{2} ρ {C}_{p}}{{π}^{2} k} \qquad ( 6 )$$

In equation (6), Tₐᵥₑ(t) is the average temperature measured in the sensor in relationship to the temperature of the water bath, I₀ is the incident ultrasound intensity, μ is the absorption coefficient, l is the length of the absorber, k is the thermal conductivity of the absorbing material, Cₚ is the heat capacity of the material, and ρ is the density of the material. Using this model, the ultrasound intensity can be inferred from the parameter Cₐ.

The thermal properties of the thermoacoustic sensor will dictate how the thermal energy propagates through the sensor. We are interested in the heat diffusivity on the back face, where the thermistor is located. The solution to (6) requires the temperature rise averaged across the back face. The goal of the sensor is to take accurate readings as quickly as possible; therefore, it is important for the temperature to rapidly spread across the back face. To investigate the diffusion of heat, equation (7) and the thermal properties outlined in Table 2 were used to calculate the thermal diffusivity of various materials. The thermal diffusivity (α) expresses the rate a material transfers heat from one point to another and is related to the thermal conductivity (k), density (ρ) and heat capacity (C) of the material.

$$α = \frac{k}{ρ C} \qquad ( 7 )$$

TABLE 2
THERMAL PROPERTIES OF THERMOACOUSTIC SENSOR

| Material | Thermal Conductivity (k) | Heat Capacity (C) |
|---|---|---|
| Plexiglass | 0.167 W/(m * K) | 1300 J/(kg * K) |
| Copper | 401 W/(m * K) | 385 J/(kg * K) |

Plexiglass has a thermal diffusivity of 1.09×10⁻⁷ m²/s. Copper, a material with a high thermal conductivity, has a thermal diffusivity of 1.18×10⁻⁴ m²/s, 3-orders of magnitude greater than plexiglass, allowing it to conduct heat at a much faster rate. A thin copper sheet (0.30 mm) was attached to the back face of the absorber using a thermal paste; this equally distributes the temperature across the whole surface faster than the plexiglass material. The temperature sensing thermistor was placed on top of the copper layer. Care was taken to ensure that the copper didn't short the thermistor leads.

Temperature readings are taken using an oversampled analog to digital converter (ADC). Oversampling the ADC increases the resolution and reduces the noise of each reading. The ATmega324P microcontroller's ADC has a 10-bit resolution. In order to measure the minute changes in temperature caused by the ultrasound beam, we increased the resolution by 4 bits using oversampling techniques.

A least squares equation is implemented to fit temperature vs. time data to the equation described in (2). The implemented least squares algorithm was programmed in C onto an Atmel ATmega324P microcontroller. Every 0.1 seconds a temperature and time reading are taken and fit to equation (6) and the coefficients are estimated. An iterative process with an experimentally determined R2 value of 0.00001 and step size of 0.001 is used.

### EXAMPLE 1

### Thermistor Calibration

After construction, the thermal response of the sensor was characterized. Thermal calibration was carried out by placing the sensor in a heated water bath and measuring the changes in the thermistor's electrical resistance with respect to changes in temperature. A thermocouple with an accuracy of 0.1° C. was attached to the sensor's thermistor and employed to record temperature changes relative to the thermistor's ADC readouts. In accordance with the operation of a negative temperature coefficient thermistor, the resistance decreased as the temperature increased. There was a linear correlation between the change in resistance and the temperature, with a coefficient of determination of 0.999 and a slope shown in equation (9). The slope of the graph was used to convert the change in the thermistor's resistance to a digital temperature value.

T=−0.01717X+78.79 (9)

Here X is the ADC readout. This relationship was programmed into the microcontroller operating the thermoacoustic sensor, allowing the sensor's temperature to be calculated.

### EXAMPLE 2

### Transducer Energy Characterization

Equation (10) shows the ratio of the power out of the transducer with respect to the power into the transducer, using the root mean squared voltage and current inputted into a piezoelectric transducer, and measuring the output power with a radiation force balance.

$$\frac{{P}_{out}}{{P}_{in}} = 0.4519 \qquad ( 10 )$$

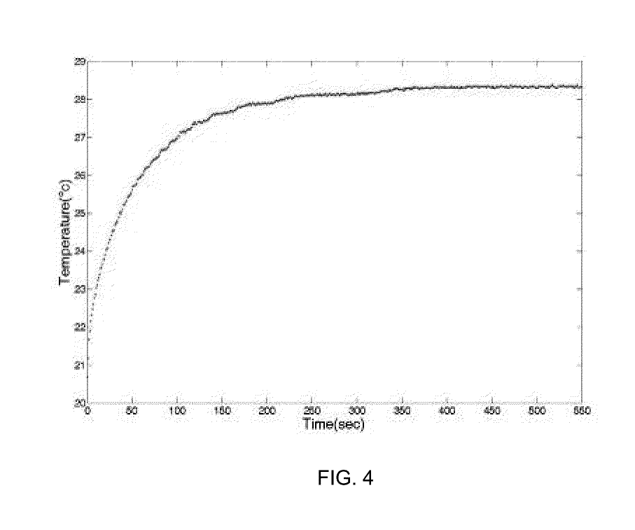

Approximately 55% of the input energy is lost during the conversion of electrical energy to mechanical energy; a portion of this is due to the internal friction of the transducer, which results in thermal energy. In a close-proximity setup model, the heat produced by the transducer will influence the temperature readings and the measurement accuracy. A thin layer of ultrasound gel was originally used, and the self-heating effect of the transducer made the sensor's calibration and measurement highly dependent on the construction of the ultrasound transducer, since a transducer made out of a different material would generate a different amount of heat. Due to the heat produced by the transducer, we used degassed water as an ultrasound medium. The heat generated by the transducer is dispersed throughout the water and will not affect the sensor's readings. FIG. 4 shows a typical temperature vs. time curve at intensity of 40 mW/cm². At time t=0 the ultrasound generator was turned on, and remained on throughout the whole process. The largest increase in temperature occurs between t=0 and t=150 seconds, and the equilibrium temperature is not reached until t=400 seconds. If the thermoacoustic sensor algorithm required the sensor's equilibrium temperature, the sensor's response time would be longer than 400 seconds. Therefore, an algorithm based on a transient equation describing the spatially averaged temperature across the back face of the sensor was needed.

### EXAMPLE 3

### Transient Temperature Model Analysis

To evaluate the transient model with a thermoacoustic sensor implemented in a close proximity setup, measured data was collected and the least squares model was used to fit the curve, equation (11):

$${T}_{ave} ( t ) = C ( 1 - {e}^{\frac{- t}{τ}} ) + {T}_{0} . \qquad ( 11 )$$

The value Tₐᵥₑ is the measured temperature averaged across the absorber's back face; T₀ is the starting temperature. The thermoacoustic sensor was coupled using degassed water in direct contact with the SonaCell™ ultrasound transducer. When the ultrasound generator was turned on, the thermoacoustic sensor began measuring the change in temperature at the absorber's back face. The temperature vs. time curve with incident ultrasound intensity of 80 mW/cm², for example, is measured. Using the least squares method and MATLAB's curve fitting toolbox, the transient model was evaluated. The curve described in equation (11) was fit to the measured data with prediction bounds with 95% certainty (calculated using the MATLAB curve fitting toolbox), at an ambient temperature of 24° C. The coefficients of the transient model are displayed in Table 3.

TABLE 3
COEFFICIENTS OF THE TRANSIENT MODEL FOR AN
APPLIED ULTRASOUND INTENSITY OF
80 MW/CM² AT 24° C.

| | Coefficient C | Coefficient τ | Coefficient T₀ |
|---|---|---|---|
| Ultrasound | (95% Confidence | (95% Confidence | (95% Confidence |
| Intensity | Bounds) | Bounds) | Bounds) |
| [mW/cm²] | [° C.] | [sec] | [° C.] |
| 80 | 6.905 | 153.1 | 24.09 |
| | (6.813, 6.997) | (148.9, 157.2) | (24.07, 24.11) |

The 95% confidence bound indicates that the model is 95% confident that the mean value will fall in between the upper and lower bounds. A smaller interval width is desirable because it indicates that in subsequent trials the calculated coefficient values will be near the mean value determined by this curve fitting session.

The accuracy of fit analysis calculated by the MATLAB curve fitting toolbox is outlined in Table 4.

TABLE 4
ACCURACY OF FIT ANALYSIS FOR DATA
(AN APPLIED ULTRASOUND INTENSITY OF
80 MW/CM² AT 24° C.)

| Ultrasound | Sum of | R-Squared | Root Mean |
|---|---|---|---|
| Intensity | Squares | Value | Squared Error |
| 80 mW/cm² | 0.4077 | 0.999 | 0.04549 |

The sum of squares of residuals (SSE) value measures the total deviation between the measured data (y) and the predicted data (ŷ) calculated by the fitted curve.

SSE=Σₗ₌₁ⁿ rᵢ²=Σₗ₌₁ⁿ(yᵢ−ŷᵢ)² (12)

The R-squared value is the square of the correlation between the measured data and the predicted value.

$$S S T = {\sum }_{i = 1}^{n} {( {y}_{i} - \overline{y} )}^{2} \\ {R}_{square} = 1 - \frac{S S E}{S S T} \qquad ( 13 )$$

SST is the sum of squares about the mean, where (ŷ) is the overall mean. An R-squared value closer to 1 indicates that a great proportion of variance is accounted for by the model. Finally, the root mean squared error (RMSE) is an estimate of the standard deviation of the random component of the data. The RMSE calculation is shown in the equation below, where (n) is the number of terms.

$$M S E = \frac{S S E}{n} \\ R M S E = \sqrt{M S E} \qquad ( 14 )$$

An RMSE value closer to 0 indicates that the model is more useful for prediction. After using the MATLAB curve fitting toolbox to analyze the goodness of fit of equation (11) to the measured temperature vs. time data collected when a 80 mW/cm² ultrasound intensity, for instance, was applied to the thermoacoustic sensor, we can conclude that the least squares method does fit the curve to the measured data.

### EXAMPLE 4

### Substitution Characterization

Acoustic Calibration

Substitution calibration involves calibrating the ultrasound generator using a known calibration modality, in this case a radiation force balance, and then the calibrated ultrasound generator is employed to find a relationship between the thermoacoustic sensor's recorded temperature and the applied ultrasound. Four ultrasound transducers with surface area of 3.5 cm² were operated at a 1.5 MHz frequency with a 20% duty cycle and 1 kHz pulse repetition frequency. The transducers, driven by a SonaCell ultrasound generator (IntelligentNano Inc., Edmonton, Alberta, Canada), were initially calibrated using a radiation force balance (Ohmic Instruments Co., Maryland) at 40, 60, 80, and 100mW/cm², respectively.

The C coefficient (in ° C.) was calculated using the least squares method to fit the curve described in equation (11) to temperature data measured over time at different ultrasound intensities. A constant τ value, determined experimentally (τ=130 sec), was used, and the ambient temperature T0 was measured, and found to be 24° C., before readings were taken. There is a linear relationship between the calculated C coefficient and the applied ultrasound intensity, as suggested by equation (11). The linear relationship between the applied ultrasound intensity (I) and the calculated C coefficient is,

I=9.637×C+6.973 (15)

The R-squared value is 0.9962. This relationship is further analyzed and used to evaluate the thermoacoustic sensor's ability to relate applied ultrasound intensity to measure temperature after 20 seconds.

### EXAMPLE 6

### Effect of Ambient Temperature

The thermoacoustic sensor's operation relies on measuring the temperature changes produced by absorbed ultrasound waves. However, the sensor's temperature changes depend not only on the ultrasound intensity, but also on ambient temperatures. Although the thermistor in the sensor is insulated with air to remove the influence of the outside room temperature, the front face of the sensor is still affected by the ambient temperature. The ambient temperature in our design is the temperature of ultrasound medium shown in FIG. 1. If the effect of ambient temperatures is not taken into consideration, the measurement results would not be accurate and consistent. A range of ambient temperatures was measured to examine their effect on the value of the C coefficient. Table 5 outlines the calculated C value at different starting ambient temperatures between 21° C. and 26° C. for the same ultrasound intensity at 60 mW/cm².

TABLE 5
CALCULATED C COEFFICIENTS AT
VARIOUS AMBIENT TEMPERATURES

| | 21.0° C. | 22.0° C. | 23.0° C. | 24.0° C. | 25.0° C. | 26.0° C. |
|---|---|---|---|---|---|---|
| C Value [° C.] | 3.21 | 4.08 | 4.66 | 5.59 | 6.25 | 6.91 |

The difference between the C values at various starting temperatures indicates that a direct correlation between measured C coefficient values and starting ambient temperatures. A graph of the data outlined in Table 5 shows linearity between measured C coefficient values and starting ambient temperatures. The final version of the thermoacoustic sensor was calibrated using substitution calibration methods, which took the effect of ambient temperatures into consideration.

### EXAMPLE 7

### Thermoacoustic Sensor Operation

The second measurement was carried out using the designed thermoacoustic sensor. The sensor was coupled directly to the transducer through the ultrasound medium, as shown in FIG. 1 and ultrasound was applied until a stable reading was obtained. This setup is easy to operate and different from various other experimental setups (Wilkens 2010a, 2010b, 2004, 2002; Fay 1994; Fay 1996b) using thermoacoustic sensors where the sensor and the transducer are operated in a large degassed water bath.

Using equation (14) to relate the ultrasound intensity to the calculated C coefficients determined from the measured temperature increases over time, the performance of the calibrated thermoacoustic sensor was evaluated. By comparing readings taken by a radiation force balance to readings taken using the calibrated thermoacoustic sensor, we examined the agreement between both techniques.

Six transducers were calibrated to nominal levels of 30, 40, 60, 80, 100, and 120 mW/cm² using a radiation force balance. The output intensity of the same transducers was then measured using the thermoacoustic sensor. This process simulates a new user taking a fresh reading every time, making it a practical evaluation of the thermoacoustic sensor's operation. Table 6 outlines the measurements taken using the thermoacoustic sensor.

TABLE 6
THERMOACOUSTIC SENSOR MEASUREMENTS

| | | Measurements | | | |
|---|---|---|---|---|---|
| | Target | #1 | | #3 | Average |
| | [mW/cm²] | [mW/cm²] | #2 [mW/cm²] | [mW/cm²] | [mW/cm²] |
| 1 | 30.14 | 26.84 | 28.72 | 28.47 | 28.01 |
| 2 | 40.28 | 37.38 | 36.94 | 37.80 | 37.37 |
| 3 | 59.09 | 59.59 | 61.19 | 62.90 | 60.32 |
| 4 | 80.58 | 86.11 | 85.40 | 85.76 | 85.76 |
| 5 | 100.25 | 105.01 | 105.86 | 105.65 | 105.51 |
| 6 | 120.73 | 126.72 | 125.23 | 127.34 | 126.43 |

Table 7 compares the measurements made by the radiation force balance and our thermoacoustic sensor. The thermoacoustic sensor had an output with an average error of 5.46% across 18 measurements.

TABLE 7
COMPARISON BETWEEN MEASUREMENTS MADE USING A
RADIATION FORCE BALANCE AND MEASUREMENTS MADE
USING A THERMOACOUSTIC SENSOR

| | Radiation Force Balance | Thermoacoustic Sensor | Error |
|---|---|---|---|
| 1 | 30.14 mW/cm² | 28.01 mW/cm² | 7.07% |
| 2 | 40.28 mW/cm² | 37.37 mW/cm² | 7.22% |
| 3 | 59.09 mW/cm² | 60.32 mW/cm² | 2.08% |
| 4 | 80.58 mW/cm² | 85.76 mW/cm² | 6.43% |
| 5 | 100.25 mW/cm² | 105.51 mW/cm² | 5.25% |
| 6 | 120.73 mW/cm² | 126.43 mW/cm² | 4.72% |

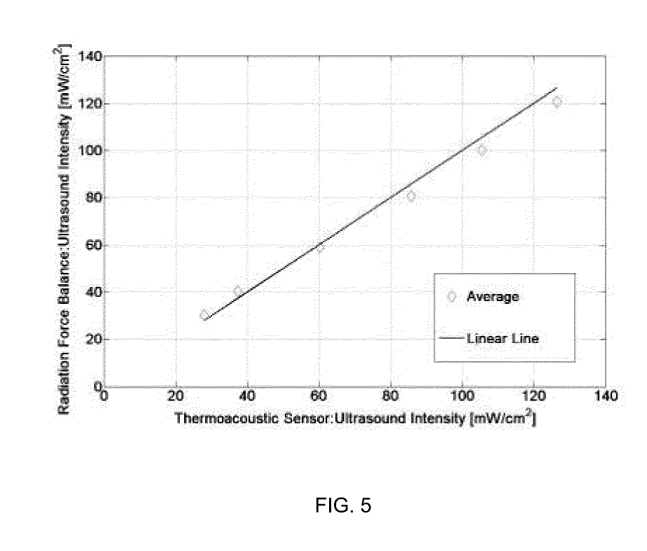

The result in FIG. 5 shows linearity between ultrasound intensity readings taken using a radiation force balance and measurements taken using the thermoacoustic sensor.

### EXAMPLE 8

### Effect of the Back Face Copper Sheet

Since readings by the thermoacoustic sensor are based on the temperature across the back face of the sensor, a thin copper sheet (0.30 mm thick) was attached to the plexiglass material using a thermal paste to distribute heat quickly and uniformly such that the temperature measured at one location is assumed to be the average temperature across the entire back face. If there was not a uniform change in temperature, the goal would be to quickly distribute the heat from one location across the entire surface. Discrepancies between readings arise if the ultrasound energy heats an area away from the thermistor on a material with low thermal diffusivity.

As seen in Table 8, the average standard deviation when the transducer is placed in different locations on the copper backed sensor is 58.2% less than the average standard deviation of the sensor without the copper back. This is due to the higher thermal diffusivity of the copper compared to the plexiglass material allowing the temperature to dissipate across the back face more evenly.

TABLE 8
THE IMPACT OF SENSOR-TRANSDUCER-ORIENTATION ON
THERMOACOUSTIC SENSOR OPERATION

| | Bottom | Left | Middle | Right | Top | STDEV |
|---|---|---|---|---|---|---|
| | [° C.] | [° C.] | [° C.] | [° C.] | [° C.] | [%] |
| Copper Backed | | | | | | |
| Set 1 | 8.2495 | 8.3120 | 8.2963 | 8.1870 | 8.4057 | 0.0812 |
| Set 2 | 8.4760 | 8.4525 | 8.6087 | 8.4603 | 8.5931 | 0.0765 |
| Set 3 | 8.6009 | 8.6946 | 8.8196 | 8.7181 | 8.5931 | 0.0929 |
| Avg | | | | | | 0.0836 |
| No Copper | | | | | | |
| Set 1 | 7.9371 | 7.9605 | 8.0308 | 8.3041 | 8.7337 | 0.3358 |
| Set 2 | 8.7337 | 8.9914 | 8.7259 | 9.0695 | 8.7337 | 0.1663 |
| Set 3 | 9.3663 | 9.4756 | 9.4366 | 9.4444 | 9.6318 | 0.0984 |
| Avg | | | | | | 0.2002 |

The results shown in the lower half of Table 8 clearly illustrate why the sensor without copper backing cannot yield accurate results. At the same starting temperature, the calculated C coefficients must be close to the same value at every reading. This is especially important because substitution calibration methods are used. Once the sensor is calibrated, the same C coefficient that correlates to a specific ultrasound intensity should be generated every time that particular ultrasound intensity is applied. Conversely, the results shown in the upper half of table 8 show that the sensor with the copper backing can generate more consistent results. The algorithm implemented requires that measurements be taken using the average temperature across the absorber's back face. In order to record the average temperature, multiple sensors or a high conductivity surface must be used to rapidly distribute heat across the back face (Myers and Herman 2002).

### REFERENCES

Cheeke J D N. Fundamentals and applications of ultrasonic waves, Boca Raton: CRC Press, 2002

Ensminger D. Ultrasonics: Fundamentals, technology, applications (Second ed.). M. Dekker, 1988.

Ensminger D. Ultrasonics: Data, equations, and their practical uses. CRC Press, 2009.

Fay B, Rinker M, Lewin P A. Thermoacoustic sensor for ultrasound power measurements and ultrasonic equipment calibration. Ultrasound in Medicine & Biology 1994; 20(4):367-373.

Fay B, Rinker M. Determination of absolute value of ultrasonic power by means of thermoacoustic sensors. Acustica 1996; 82:274-279.

Fay B, Rinker M. The thermoacoustic effect and its use in ultrasonic power determination. Ultrasonics 1996; 34(2-5):563-566.

Myers M R, Herman B A. A theoretical assessment of a thermal technique to measure acoustic power radiated by ultrasound transducers. IEEE Transactions on Ultrasonics, Ferroelectrics, and Frequency Control 2002; 49(5):565-572.

Shaw A, Hodnett M. Calibration and measurement issues for therapeutic ultrasound. Ultrasonics 2008; 48(4):234-252.

Wilkens V. Thermoacoustic ultrasound power measurement using evaluation of transient temperature profiles. Ultrasonics Symposium, Proceedings 2002; 2:1399-1402.

Wilkens V. Output intensity measurements on a diagnostic ultrasound machine using a calibrated thermoacoustic sensor. Journal of Physics: Conference Series 1 2004; 140.

Wilkens V. Measurement of output intensities of multiple-mode diagnostic ultrasound systems using thermoacoustic sensors. Ultrasonics Symposium 2005; 2:1122-1125.

1. A thermoacoustic ultrasound sensor, comprising:
a transducer;
an ultrasound sensor directly acoustically coupled to the transducer; and
an electronic processing unit connected to process signals from the ultrasound sensor.

2. The thermoacoustic ultrasound sensor of claim 1 in which the transducer and ultrasound sensor are directly acoustically coupled by a layer of material that conducts ultrasound and that is placed between matching surfaces of the transducer and the sensor.

3. The thermoacoustic ultrasound sensor of claim 2 in which the layer of material that conducts ultrasound comprises gel, gel pad, or agar.

4. The thermoacoustic ultrasound sensor of claim 2 in which the layer of material that conducts ultrasound comprises a degassed water film.

5. The thermoacoustic ultrasound sensor of claim 2 in which the layer of material that conducts ultrasound comprises glue.

6. The thermoacoustic ultrasound sensor of claim 2 in which the matching surfaces are flat.

7. The thermoacoustic ultrasound sensor of claim 6 in which the matching surfaces comprise a face of the sensor and a face of the transducer, and the face of the sensor is larger in area than the face of the transducer to ensure high coupling efficiency of energy into the sensor.

8. The thermoacoustic ultrasound sensor of claim 7 in which the sensor comprises a cylinder, and a temperature sensor attached to the cylinder.

9. The thermoacoustic ultrasound sensor of claim 8 in which the cylinder has a point of attachment to the temperature sensor and the point of attachment is made of a thermally conductive material that is at least as thermally conductive as copper.

10. The thermoacoustic ultrasound sensor of claim 9 in which the cylinder has a circular end wall furthest from the coupling with the transducer that is at least partially made of copper.

11. The thermoacoustic ultrasound sensor of claim 1 in which the electronic processing unit is configured to take ambient temperature into consideration.

12. The thermoacoustic ultrasound sensor of claim 1 in which the ultrasound sensor and transducer face each other across a medium that is confined between the ultrasound sensor and transducer and, in operation, ultrasound only approaches the ultrasound sensor on one side only of the ultrasound sensor.
